(19) United States
(12) Patent Application Publication
(10) Pub. No.: US 2024/0037643 A1
(43) Pub. Date: Feb. 1, 2024

(54) METHOD AND SYSTEM FOR DIGITAL CONTENTS BY USE OF RENTAL NFT

(71) Applicant: Nestyle, Inc, Seoul (KR)

(72) Inventor: Yong Kyun LEE, Gwangmyeong-si (KR)

(21) Appl. No.: 17/950,077

(22) Filed: Sep. 21, 2022

(30) Foreign Application Priority Data
Aug. 1, 2022 (KR) 10-2022-0095628

(51) Int. Cl. G06Q 30/06; G06Q 20/36; G06Q 20/40; G06Q 20/38

(52) U.S. Cl. CPC G06Q 30/0645; G06Q 20/3678; G06Q 20/40; G06Q 20/389; G06Q 2220/00

(57) ABSTRACT

A technical idea of the present disclosure may include issuing an original NFT authenticating ownership of a digital file; storing an original digital file authenticated by the original NFT in a safe distributed storage; generating a copy of a digital file for lease including lessee-related information; storing the copy of the generated digital file for leasing in a leased distributed storage; generating a temporary Uniform Resource Locator (URL) enabling access to the copy of the digital file for lease; and issuing an original NFT authenticating a lease right of the digital file.

### CROSS-REFERENCE TO RELATED APPLICATION

This application claims priority to and the benefit of Korean Patent Application No. 10-2022-0095628, filed on Aug. 1, 2022, the disclosure of which is incorporated herein by reference in its entirety.

### BACKGROUND

### Field of the Invention

The present invention relates to a method and system for temporally leasing digital content by use of a non-fungible token (NFT). More particularly, the present invention relates to a system and method for leasing an NFT for storing original digital content in a separate storage that cannot be accessed by a third party and leasing digital content by temporarily providing a storage-accessible Uniform Resource Locator (URL).

### Discussion of Related Art

Recently, as a method of authenticating ownership of digital content and selling digital content through the authentication, non-fungible tokens are attracting attention because non-fungible tokens may prove a transaction of ownership on a network connected to the Internet. The global NFT market size is expected to reach $40 billion in 2021, and the NFT market size is growing in the art industry, the game industry, and the like due to the characteristics of storing transaction records and securing ownership on a blockchain that cannot be arbitrarily modified.

An NFT may guarantee uniqueness by permanently leaving an encrypted transaction history on a blockchain. Therefore, for example, creators create (generate) their own unique digital data, such as image files, video files, and voice files, and then issue NFTs as a means of authenticating ownership of these creations and trade these NFTs as a means of selling the ownership of the digital data to others.

However, a concern with NFT technology is that an original file may be deleted or tampered with because it is common for the target original file not to be stored on the blockchain even if the NFT itself that proves transaction facts is issued on the blockchain and cannot be tampered with.

### SUMMARY

The present invention is directed to providing a method and system for temporally leasing digital content by use of a non-fungible token (NFT). More specifically, the present invention is directed to providing a system and method for leasing an NFT for storing original digital content in a separate storage that cannot be accessed by a third party and leasing digital content by temporarily providing a storage-accessible Uniform Resource Locator (URL).

According to an aspect of the present invention, there is provided a method of temporally leasing digital content by use of an NFT, including:
issuing an original NFT authenticating ownership of a digital file;
storing an original digital file authenticated by the original NFT in a safe distributed storage;
generating a copy of a digital file for lease including lessee-related information;
storing the copy of the generated digital file for leasing in a leased distributed storage;
generating a temporary URL enabling access to the copy of the digital file for lease; and
issuing an original NFT authenticating a lease right of the digital file.

The original NFT may be on-chain data stored in a node of a blockchain, and include at least NFT owner information, digital file original storage location information, and lease condition information.

The lease condition information may include at least lease rate information.

In the storing of the original digital file authenticated by the original NFT in the safe distributed storage, the safe distributed storage may allow access and authentication control over a communication network.

The leased NFT may be on-chain data stored in a node of a blockchain and include at least NFT lessee information, digital file copy storage location information, lease condition information, and a temporary URL.

The generating of the copy of the digital file for lease including the lessee-related information may include generating a copy by applying a steganography technique.

The method may further include determining whether the copy of the digital file for lease is leaked.

According to another aspect of the present invention, there is provided a computer-readable recording medium on which a computer program for executing the above-described method of temporally leasing digital content by use of an NFT is recorded.

According to still another aspect of the present invention, there is provided a system for temporally leasing digital content by use of an NFT, including:
an NFT issuing part configured to issue an original NFT authenticating ownership of digital content and a leased NFT authenticating a lease right;
a distributed storage management part configured to control an original distributed storage for storing original digital content and a copy distributed storage for storing copy digital content;
an electronic wallet management part configured to pay a price for sale or lease of digital content;
a blockchain management part configured to manage a ledger of the original NFT and the leased NFT issued on the blockchain;
a communication part configured to transmit or receive data to or from at least the original distributed storage and the copy distributed storage;
a copy generation part configured to generate the copy digital content after adding lessee-related information to the original digital content; and
a temporary URL generation part configured to generate a temporary URL that grants a temporal access authority to a lessee.

The original NFT may be on-chain data stored in a node of a blockchain, and include at least NFT owner information, digital file original storage location information, and lease condition information.

The leased NFT may be on-chain data stored in a node of a blockchain and include at least NFT lessee information, digital file copy storage location information, lease condition information, and a temporary URL.

The copy generation part may generate a copy by applying a steganography technique.

### BRIEF DESCRIPTION OF THE DRAWINGS

FIG. 1 is a block diagram illustrating a configuration of a system for temporally leasing digital content according to the present invention.

FIG. 2 is a block diagram illustrating a detailed configuration of a non-fungible token (NFT) transaction platform illustrated in FIG. 1.

FIG. 3 is a block diagram illustrating a detailed configuration of a distributed storage illustrated in FIG. 2.

FIG. 4 is a flowchart illustrating in detail mutual operations between components of the system for leasing digital content illustrated in FIG. 1.

FIG. 5 is a flowchart illustrating a method of temporally leasing digital content.

FIG. 6 is a diagram illustrating specific content of an original NFT and a leased NFT.

### DETAILED DESCRIPTION

Hereinafter, various exemplary embodiments of the present disclosure will be described in detail with reference to the accompanying drawings. Various advantages and features of the present disclosure and methods accomplishing them will become apparent from the following description of embodiments with reference to the accompanying drawings. However, the technical idea of the present disclosure is not limited to embodiments to be described below, but may be implemented in various different forms, only the following embodiments will be provided only in order to make the technical idea of the present disclosure complete and allow those skilled in the art to completely recognize the scope of the present disclosure, and the technical idea of the present disclosure will be defined by the scope of the claims.

It is to be noted that in giving reference numerals to components of the accompanying drawings, the same components will be denoted by the same reference numerals even though they are illustrated in different drawings. Further, in describing exemplary embodiments of the present invention, well-known functions or constructions will not be described in detail since they may unnecessarily obscure the understanding of the present invention.

Unless defined otherwise, all terms (including technical and scientific terms) used in the present specification have the same meanings as commonly understood by those skilled in the art to which the present invention pertains. In addition, terms defined in commonly used dictionaries are not ideally or excessively interpreted unless explicitly defined otherwise. Terms used in the present specification are for explaining embodiments rather than limiting the present invention. Unless otherwise stated, a singular form includes a plural form in the present specification.

Hereinafter, the present invention will be described in detail with reference to exemplary embodiments of the present invention and the accompanying drawings.

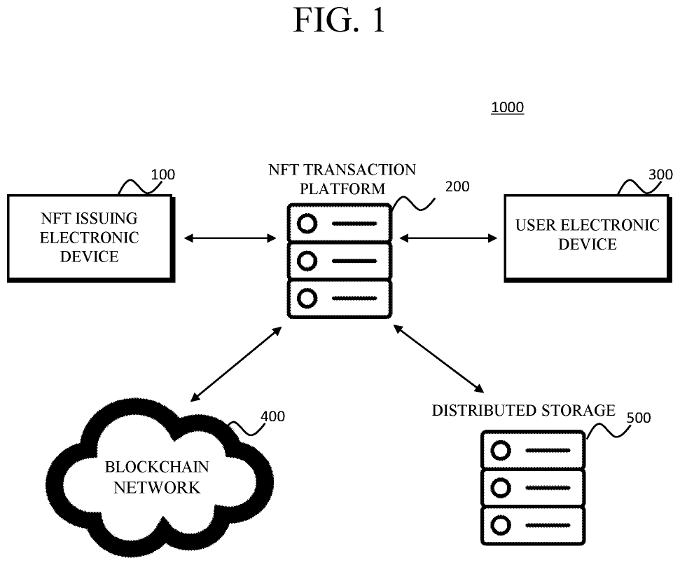

FIG. 1 is a block diagram illustrating a configuration of a system 1000 for temporally leasing digital content according to the present invention. Referring to FIG. 1, the system for temporally leasing digital content may include an NFT issuing electronic device 100, an NFT transaction platform 200, a user electronic device 300, a blockchain network 400, and a distributed storage 500. The constituent entities 100, 200, 300, 400, and 500 may be connected and communicate with each other in a wired/wireless communication network.

The NFT issuing electronic device 100 may be an electronic device terminal that has an asset to generate or sell/lease a digital content asset or has a management authority. In the electronic device 100, an owner terminal may be any portable/non-portable or wireless/wired computer device such as a smart phone, a notebook computer, a tablet computer, and a desktop computer, and is not limited to a specific example.

The digital asset may be digital content in a form that may be stored in a computer device, and may be composed of any digital data in a form that can be stored in a computer, such as image files, video files, voice files, and document files, but is not limited thereto.

The user electronic device 300 is a terminal of a lessee who wants to lease digital content owned by the NFT issuing electronic device 100. The terminal 20 of the user electronic device 300 may also be any computer device such as a smart phone, a notebook computer, a tablet computer, and a desktop computer, and is not limited to a specific example.

The blockchain network 400 is a distributed network based on the known blockchain technology. In one embodiment, the blockchain network 400 may be a network having a structure that may issue and store a non-fungible token (NFT). For example, the blockchain network 400 is an Ethereum-based blockchain network. A digital content owner may issue or buy an NFT (“original NFT”) that authenticates ownership of digital content on the known NFT issuance platforms or NFT transaction platforms (e.g., OpenSea, Rarible, etc.).

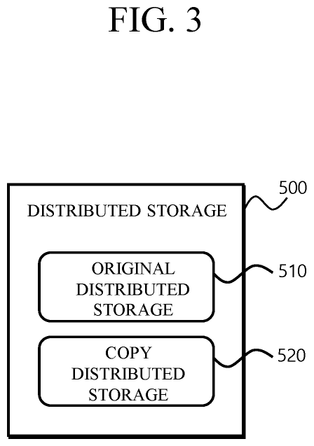

In this case, the digital content itself (hereinafter, also referred to as “original content”) may be distributed and stored in nodes on the blockchain network 400, but in general, when storing large-capacity digital content in an on-chain of the blockchain, a huge processing cost is incurred, so it is common to store the digital content in a separate storage. Accordingly, according to the present invention, original digital content and copy digital content may be separately stored using a separate distributed storage 500 as a component to improve security through authentication control and/or access control. In particular, in the case of an original file, the distributed storage 500 may be provided to secure the intended effects of the present invention, such as preventing the possibility of change/damage/loss of the original digital content by granting access to the original storage only in the case of buying and selling ownership of the digital content itself as in a “sale,” and preventing damage and leakage of the original file by granting access only to the copy digital content in the case of “lease” to allow only the copy digital content including lease-related information such as lessee information to be used for lease. Referring to FIG. 3, a detailed configuration of the distributed storage 500 is illustrated.

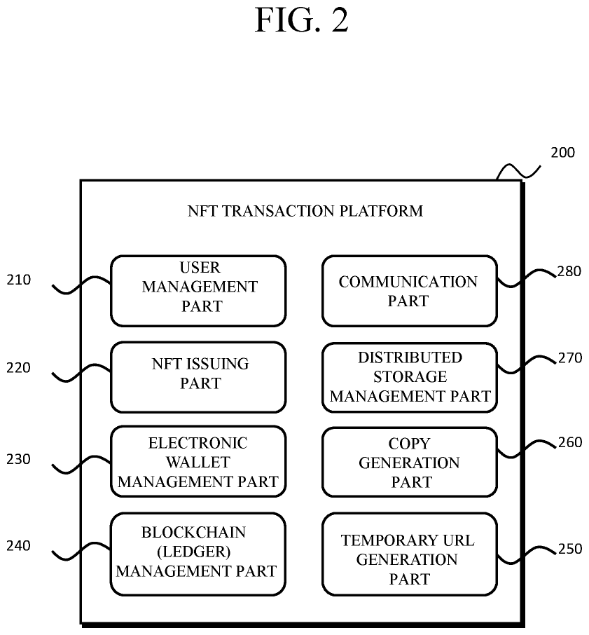

The NFT transaction platform 200 is a system that supports the original content provided from the NFT issuing electronic device 100 to enable the user electronic device 300 to make trades, such as sale/lease. In one embodiment, the NFT transaction platform 200 stores the original content in the original distributed storage so that only the owner of the “original NFT” has limited access to the original content, generates the copy content for lease, and then issues a “leased NFT,” and transmits the leased NFT to a lessee to grant the lessee only the limited access to the copy content, thereby providing lease services. A detailed configuration of the NFT transaction platform 200 will be described below with reference to FIG. 2.

Since the original digital content is encrypted and stored, key management system information for decrypting the original digital content may be provided only to the owner. In addition, authentication control information for a hash algorithm and a signature value may be provided only to an owner so that only the original NFT owner may access the safe distributed storage where the original content is stored. The signature value is a value generated by applying access control information to a predetermined hash algorithm, and the hash algorithm used at this time is recorded in a token URI. In this case, a hash target may be at least a part of access control information, that is, ownership information and key management system information, and alternatively, other information such as a storage location of the original content may be additionally included in the hash target. This content is merely an example and the present invention is not limited thereto.

FIG. 2 is a block diagram illustrating a detailed configuration of the NFT transaction platform 200 illustrated in FIG. 1. Referring to FIG. 2, the NFT transaction platform 200 includes a user management part 210, an NFT issuing part 220, an electronic wallet management part 230, a blockchain (ledger) management part 240, a communication part 280, a distributed storage management part 270, a copy generation part 260, and a temporary URL generation part 250.

The user management part 210 is a functional part that manages personal information of a seller/lessor (NFT issuing electronic device 100 in FIG. 1) and a buyer/lessee (user electronic device 300) of the digital content. For example, the user management part 210 may include at least some of functions such as membership management, member list generation and management, member account generation and management, and electronic wallet generation and management, and may include hardware resources (e.g., database, processor, storage, memory etc.) and/or software (e.g., database management system, etc.) resources to support the functions.

The user management part 210 may separately collect and manage personal information by classifying members with the purpose of selling/buying digital content and members with the purpose of leasing/rent. For example, the user management part 210 may separately collect information such as a lease period, a lease rate per lease period, a leakage prevention condition, and a use condition of a member who intends to lease/rent. For example, the user management part 210 may separately collect information such as sale costs for members who intend to sell/buy.

The NFT issuing part 220 is a functional part that issues and manages the original NFT and the leased NFT. For example, the NFT issuing part 220 may generate (issue) and store the original NFT (e.g., an NFT generated to authenticate ownership of digital content based on existing Ethereum) for the original digital content according to the request of the NFT issuing electronic device 100. Metadata of the original NFT may be stored in an on-chain of the blockchain network (400 in FIG. 1), and content data may be stored in the distributed storage 500.

For example, the NFT issuing part 220 may generate (issue) and store a leased NFT according to a lease request from the user electronic device (300 in FIG. 1). The leased NFT is an NFT for the rental of the copy digital content generated from the original digital content, and may be issued to include only information for which temporal access/a use authority for the copy digital content is granted, without including the access information on the original digital content.

For example, the NFT issuing part 220 may include hardware resources (e.g., database, processor, storage, memory, etc.) and/or software (e.g., database management system, etc.) resources to support the functions.

The electronic wallet management part 230 performs a function of transmitting a fee for the transaction to the electronic wallet of the NFT-issuing electronic device 100, which is a terminal of a right holder, when the selling of the original content or the lease of the copy content occurs through the NFT.

For example, the electronic wallet management part 230 may include hardware resources (e.g., database, processor, storage, memory, etc.) and/or software (e.g., database management system, etc.) resources to support the functions.

The blockchain management part 240 performs a function of managing the ledger of the original NFT and the leased NFT issued on the blockchain network (400 in FIG. 1).

For example, the blockchain management part 240 may include hardware resources (e.g., database, processor, storage, memory, etc.) and/or software (e.g., database management system, etc.) resources to support the functions.

The temporary URL generation part 250 is a part that performs a function of generating a temporary URL where the right holder of the leased NFT may have access to the copy content that has the same content as the original as a URL address included in the smart contract of the leased NFT. When a new lessee is generated and a transaction for a lease transaction is performed, the temporary URL generation part 250 may generate a temporary URL that operates only during a lease period. The temporary URL generation part 250 specifically generates a temporary URL enabling connection between the user electronic device (300 in FIG. 1) and a copy distributed storage 520, and the URL makes it impossible to access the original distributed storage 510, thus not providing access to the original digital content.

For example, the temporary URL generation part 250 may include hardware resources (e.g., database, processor, storage, memory, etc.) and/or software (e.g., database management system, etc.) resources to support the functions.

The copy generation part 260 generates the copy digital content after adding the lessee-related information to the original digital content. The copy generation part 260 may generate a copy by applying a steganography technique. For example, the copy generation part 260 may generate a copy content file including at least NFT lessee information, digital file copy storage location information, lease condition information, and a temporary URL along with the content of the original content.

For example, the copy generation part 260 may include hardware resources (e.g., database, processor, storage, memory, etc.) and/or software (e.g., database management system, etc.) resources to support the functions.

The distributed storage management part 270 is configured to manage access to the original distributed storage 510 and the copy distributed storage 520 of the distributed storage 500. Specifically, the distributed storage 500 is a functional part that allows only authorized persons to access the stored digital content. In an embodiment, the NFT transaction platform 200 may generate a path (hereinafter also referred to as “access path” or “access information”) accessible to the original distributed storage 510 when generating the original NFT and include the path in the original NFT. An original NFT owner may request access to the distributed storage management part 270 according to the access information included in the original NFT, and the distributed storage management part 270 may verify the access information to determine whether an owner is an authorized owner, and then permit access to the digital content. Damage to the original digital content may be prevented by blocking access of the unexpected lessee to the original distributed storage 510.

For example, the copy generation part 270 may include hardware resources (e.g., database, processor, storage, memory, etc.) and/or software (e.g., database management system, etc.) resources to support the functions.

In addition, the distributed storage management part 270 may permit access to the copy digital content after determining whether the user is the authorized owner in the case of access through the temporary URL according to the request of the lessee, that is, the owner of the leased NFT. In the case of the leased NFT and the copy digital content, as described above, since lease information that may identify that it is a specific lessee is included, when the copy content data is leaked, there is an advantage that a leaker and the leaked leased NFT may be specified.

The NFT transaction platform 200 may include a server including a processor and memory. However, the present invention is not limited thereto, and other general-purpose elements such as a communication module may be further included in the server.

The memory may have a structure for storing various commands or data processed by the server. For example, the memory may be implemented as a non-volatile memory such as a read-only memory (ROM), a programmable read-only memory (PROM), an erasable programmable read-only memory (EPROM), an electrically erasable programmable read-only memory (EEPROM), a flash memory, a phase-change random access memory (PRAM), a magnetic random access memory (MRAM), a resistive random access memory (RRAM), and a ferroelectric random access memory (FRAM), or a volatile memory such as dynamic random access memory (DRAM), a static random access memory (SRAM), a synchronous dynamic random access memory (SDRAM), a phase-change random access memory (PRAM), a resistive random access memory (RRAM), and a ferroelectric random access memory (FeRAM), and may be implemented in the form of a hard disk drive (HDD), a solid state drive (SSD), secure digital (SD), Micro-SD, or the like, or a combination thereof.

The processor may have a structure for performing processing processes required for the operation of the NFT transaction platform 200. The processor may be implemented as an array of a plurality of logic gates or a general-purpose microprocessor for processing various operations inside the server, and may be configured as a single processor or a plurality of processors. For example, the processor may be implemented in the form of at least one of a central processing part (CPU), a graphics processing part (GPU), and an application processor (AP).

The processor may execute instructions stored in a memory to control the user management part 210, the NFT issuing part 220, the electronic wallet management part 230, the blockchain (ledger) management part 240, the communication part 280, the distributed storage management part 270, the copy generation part 260, and the temporary URL generation part 250 which are components of the NFT transaction platform 200.

Referring to FIG. 3, the distributed storage 500 is illustrated. The distributed storage 500 may include an original distributed storage 510 and a copy distributed storage 520. The distributed storage 500 may be implemented as a distributed storage system such as an InterPlanetary File System (IPFS), and is not limited to a specific example.

The original distributed storage 510 may store the original digital content. In the case of the original file, the access to the original storage may be granted only in the case of buying and selling the ownership of the digital content itself, such as a “sale.”

The original distributed storage 520 may store the copy digital content. In the case of the copy file, the intended effects of the present invention such as preventing the possibility of change/damage/loss of the original digital content by granting access only to the copy digital content as in “lease,” and preventing damage and leakage of the original file by allowing only the copy digital content including lease-related information such as lessee information to be used for lease may be secured as described above.

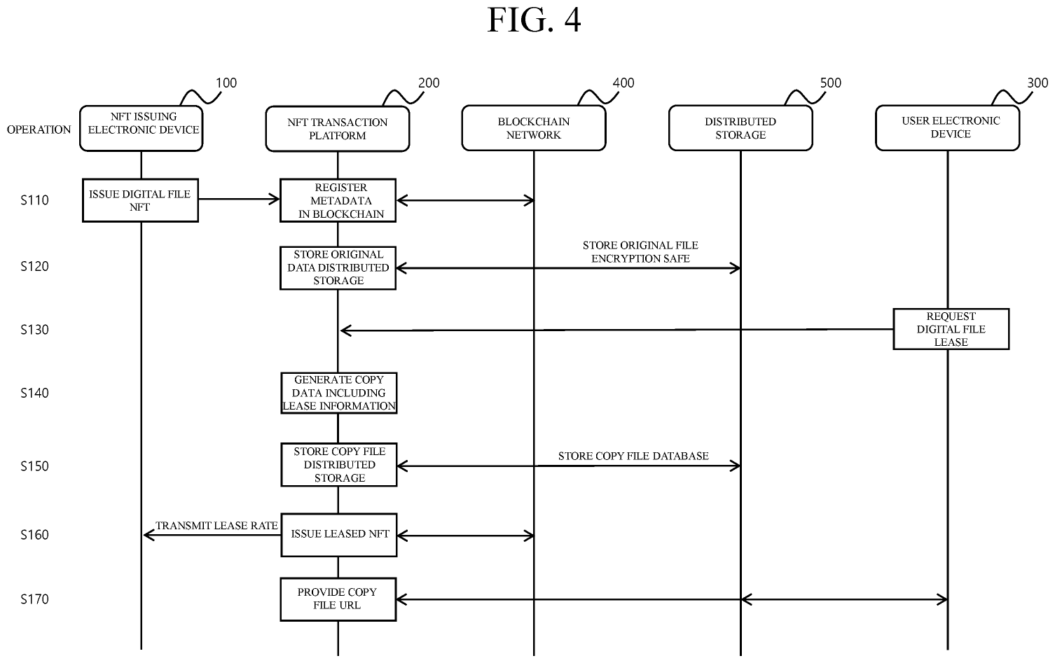

FIG. 4 is a flowchart illustrating in detail mutual operations between components of the system for leasing digital content illustrated in FIG. 1. Specific operations of the NFT issuing electronic device 100, the NFT transaction platform 200, the user electronic device 300, the blockchain network 400, the distributed storage 500, and the like are illustrated.

In operation S110, the NFT issuing electronic device 100 may request the platform 200 to issue an original NFT for a digital file. The NFT transaction platform 200 may issue an original NFT, and then register the issued original NFT on the blockchain network 400.

In operation S120, the platform 200 may store the original digital content data in the distributed storage 500. The original file may be stored in the distributed storage 500 in an encrypted state so that an unauthorized third party may not identify the original file. As described above, the distributed storage 500 is configured to separate the storages for the original file and the copy file, thereby preventing the damage to the original file.

In operation S130, the user electronic device 300 may identify the content of the digital file in the NFT transaction platform 200 and suggest a lease request for the file.

In operation S140, the platform 200 may generate the copy digital content data to perform a lease on the file. The copy digital content data may be generated to include data equivalent to the original digital content data, as well as including lease information and additional lease information to specify a lessee.

The copy file generated in operation S150 may be stored in the distributed storage 500. The storage of the copy file is stored separately from the storage of the original file.

In operation S160, the leased NFT including content of a lease contract for digital content, a lease rate agreement, an access authority to a copy file, and a URL address may be issued on the blockchain network 400. In this case, the lease rate determined by the contract may be transmitted to the electronic wallet of the NFT issuing electronic device 100 that is the owner of the original digital content.

In operation S170, a lessee may temporally access the copy digital content only during the lease period specified by the leased NFT through the URL for the copy file.

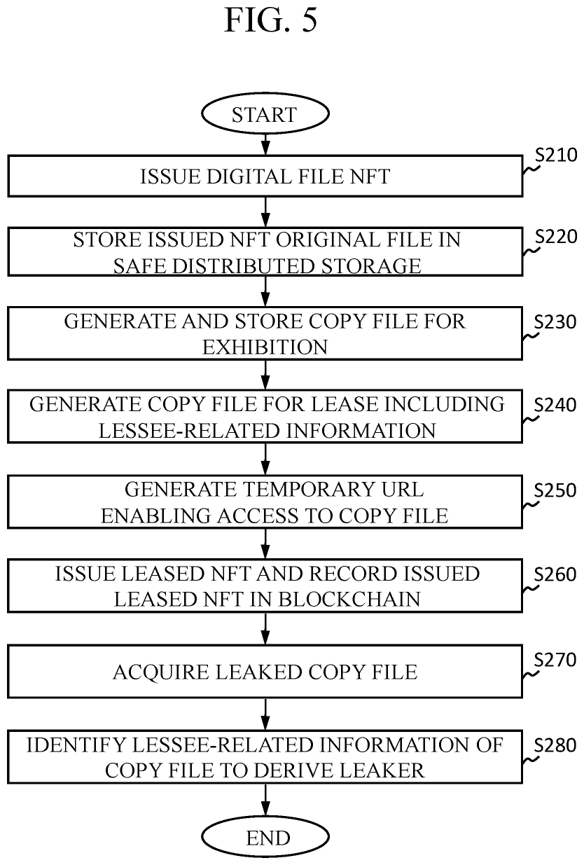

FIG. 5 is a flowchart illustrating a method of temporally leasing digital content.

Referring to FIG. 5, the method of temporally leasing digital content includes issuing a digital file NFT S210, storing the issued NFT original file in a safe distributed storage S220, generating and storing a copy file for exhibition S230, generating a copy file for lease including lease user-related information S240, generating a temporary URL enabling access to the copy file S250, issuing a leased NFT and recording the leased NFT in the blockchain S260, obtaining the leaked copy file S270, and identifying lease user-related information of the copy file and deriving a leaker S280.

Redundant description will be omitted, and details of operations not described in the method according to FIG. 4 will be described below.

The operation S230 of generating and storing the copy file for exhibition may be an operation of generating and storing the copy file for exhibition in which a part of the digital content is provided in a limited manner so that a user who wants to lease may access and identify the NFT transaction platform 200. The copy file for exhibition is different from the copy file provided for lease.

The operation S270 of obtaining the leaked copy file may be an operation of collecting digital content data traded in the NFT transaction platform 200 in the form of a WEB search and crawling in the NFT transaction platform 200 in FIG. 2.

The method may include an operation S280 of identifying the lease user-related information of the copy file and deriving a leaker. As the collection result, it is stipulated that the copy file is not disclosed to the outside, and when data that needs to be used by a lessee specified only in the NFT transaction platform 200 in FIG. 2 is leaked, it is possible to derive a leaker after specifying lease information and lessee information included in the copy data.

In the case of the technology according to the present invention, the original data is composed only of content, but since the data corresponding to the transaction is included in the copy data and also included in the leased NFT, it is possible to derive a leaker when the copy data is collected.

Therefore, it is possible to prevent data of an original right holder from being arbitrarily re-traded or used by a third party without legitimate authority or by a lessee with malicious intent.

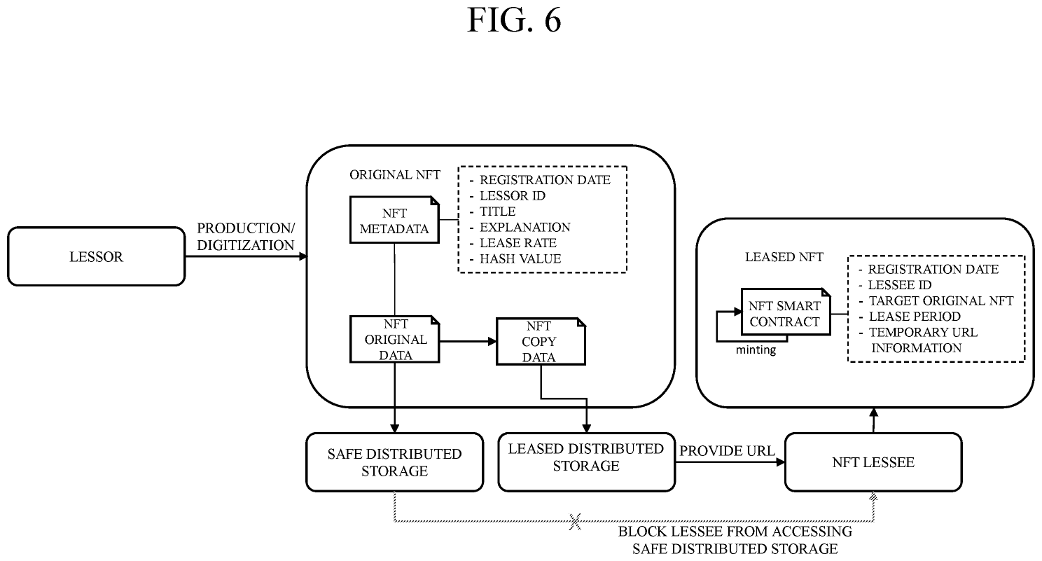

FIG. 6 is a diagram illustrating specific content of the original NFT and the leased NFT. Referring to FIG. 6, the original NFT produced and digitized by a lessor may be composed of NFT metadata, NFT original data, and copy data. The NFT metadata may include information such as a registration date, lessor (owner) information, a title, a description, a lease rate, and a hash value, and the metadata can be directly recorded on the blockchain as on-chain data. As described above, the NFT original data may be stored in a safe original distributed storage, and the copy data may be stored in a leased distributed storage that can be accessed only by providing a URL to the outside.

The owner information is, for example, information identifying the original NFT owner, and may be, for example, electronic wallet information of the NFT owner. However, the NFT owner information is not limited thereto and may be replaced with any identification information capable of identifying the owner.

The leased NFT includes metadata including a registration date, a lessee ID, a target original NFT, a lease period, and temporary URL information, and a smart contract for a lease contract may be minted on the blockchain. The lessee may access the copy digital content stored in the leased distributed storage through the provided URL but may not access the safe distributed storage to which access from the outside is limited.

The method according to the invention may be implemented by a program code. The program code may be executed by a non-transitory storage medium. The program code is executed by a hardware processor, and the program code may be executed to trade an artificial intelligence pipeline in the distributed blockchain network 400 according to the ownership information generated based on the NFT.

The blockchain network 400 may store and manage a database including a plurality of block states that are updated according to one or more transactions associated with a function received from a client device.

In firmware and/or software implementation, the techniques may be implemented as instructions stored on computer-readable media such as a random access memory (RAM), a ROM, a non-volatile random access memory (NVRAM), a PROM, an EPROM, an EEPROM, a flash memory, a compact disc (CD), and a magnetic or optical data storage device. The instructions may be executable by one or more processors, and may allow the processor(s) to perform certain aspects of the functionality described in this disclosure.

When implemented in software, the techniques may be stored on a computer-readable medium as one or more instructions or code, or transmitted over the computer-readable media. The computer-readable media include both computer storage media and communication media including any medium that facilitates transmission of a computer program from one location to another. The storage media may be any available media that may be accessed by a computer. As a non-limiting example, such computer-readable media may include a RAM, ROM, EEPROM, CD-ROM or another optical disk storage, a magnetic disk storage or another magnetic storage device, or desired program codes in the form of instructions or data structures, and any other media that may be used for transporting or storing desired program codes in the form of instructions or data structures and may be accessed by a computer. In addition, any access is properly called a computer-readable medium.

A software module may reside in a RAM memory, a flash memory, a ROM memory, an EPROM memory, an EEPROM memory, a register, a hard disk, a removable disk, a CD-ROM, or any other form of storage medium known in the art. An exemplary storage medium may be coupled to a processor such that the processor may read information from, or write information on, the storage medium. Alternatively, the storage medium may be integrated into the processor. The processor and the storage medium may reside within an application specific integrated circuit (ASIC). The ASIC may be in a user terminal. Alternatively, the processor and the storage medium may exist as separate components in the user terminal.

According to the technical idea of the present invention, it is possible to solve problems related to an NFT transaction and lease on the existing blockchain network which is vulnerable to leakage and damage of an original file, minimize the leakage of the original file, issue a leased NFT that provides a temporary Uniform Resource Locator (URL) to enable the NFT to be leased to multiple third parties, and smoothly provide an NFT lease service through management of a copy file by introducing the related distributed storage control concept.

Hereinabove, exemplary embodiments of the present invention have been disclosed in the accompanying drawings and the specification. Although the embodiments have been described using specific terms in the present specification, these are used only for the purpose of explaining the technical spirit of the present disclosure and not used to limit the meaning or the scope of the present disclosure described in the claims. Therefore, it will be understood therefrom by those skilled in the art that various modifications and other equivalent embodiments are possible. Accordingly, the true technical protection scope of the present disclosure should be defined by the technical idea of the appended claims.

What is claimed is:

1. A method of temporally leasing digital content by use of a non-fungible token (NFT), which is performed by a server including a processor, the method comprising:
issuing an original NFT authenticating ownership of a digital file;
storing an original digital file authenticated by the original NFT in a safe distributed storage;
generating a copy of a digital file for lease including lessee-related information;
storing the copy of the generated digital file for leasing in a leased distributed storage;
generating a temporary Uniform Resource Locator (URL) enabling access to the copy of the digital file for lease; and
issuing an original NFT authenticating a lease right of the digital file.

2. The method of claim 1, wherein the original NFT is on-chain data stored in a node of a blockchain and includes at least NFT owner information, digital file original storage location information, and lease condition information.

3. The method of claim 2, wherein the lease condition information includes at least lease rate information.

4. The method of claim 1, wherein, in the storing of the original digital file authenticated by the original NFT in the safe distributed storage, the safe distributed storage allows access and authentication control over a communication network.

5. The method of claim 1, wherein the leased NFT is on-chain data stored in a node of a blockchain and includes at least NFT lessee information, digital file copy storage location information, lease condition information, and a temporary URL.

6. The method of claim 1, wherein the generating of the copy of the digital file for lease including the lessee-related information includes generating a copy by applying a steganography technique.

7. The method of claim 1, further comprising determining whether the copy of the digital file for lease is leaked.

8. A computer-readable recording medium on which a computer program for executing the method of temporally leasing digital content of claim 1 is recorded.

9. A system for temporally leasing digital content by use of a non-fungible token (NFT), the system comprising:
an NFT issuing part configured to issue an original NFT authenticating ownership of digital content and a leased NFT authenticating a lease right;
a distributed storage management part configured to control an original distributed storage for storing original digital content and a copy distributed storage for storing copy digital content;
an electronic wallet management part configured to pay a price for sale or lease of digital content;
a blockchain management part configured to manage a ledger of the original NFT and the leased NFT issued on the blockchain;
a communication part configured to transmit or receive data to or from at least the original distributed storage and the copy distributed storage;
a copy generation part configured to generate the copy digital content after adding lessee-related information to the original digital content; and
a temporary URL generation part configured to generate a temporary URL that grants a temporal access authority to a lessee.

10. The system of claim 9, wherein the original NFT is on-chain data stored in a node of a blockchain and includes at least NFT owner information, digital file original storage location information, and lease condition information.

11. The system of claim 9, wherein the leased NFT is on-chain data stored in a node of a blockchain and includes at least NFT lessee information, digital file copy storage location information, lease condition information, and a temporary URL.

12. The system of claim 9, wherein the copy generation part generates a copy by applying a steganography technique.
